(19) United States
(12) Patent Application Publication
(10) Pub. No.: US 2008/0301541 A1
(43) Pub. Date: Dec. 4, 2008

(54) ONLINE INTERNET NAVIGATION SYSTEM AND METHOD

(76) Inventor: Ron KARIDI, Herzliya (IL)

Correspondence Address: EDWARD LANGER;c/o SHIBOLETH YISRAELI ROBERTS ZISMAN & CO., 1 PENN PLAZA-SUITE 2527, NEW YORK, NY, 10119, US

(21) Appl. No.: 11/740,292

(22) Filed: Apr. 26, 2007

Related U.S. Application Data
(60) Provisional application No. 60/745,751, filed on Apr. 27, 2006.

(51) Int. Cl. G06F 17/00

(52) U.S. Cl. 715/206

(57) ABSTRACT

A method and a system for enabling website navigation, the method comprising: providing web-page tags with capabilities for rendering specific content for each visitor to a web page/site based on the past and current behavior of the visitor; providing configurable content templates and editable content embedded in the webpage/site; and providing a real-time delivery means and a configuration means for the real-time delivery of the specific content to a webpage/site and for configuring the specific content of the webpage/site, respectively. A marketer is enabled to configure the specific content via the system using the web-page tags and is also given the ability to embed automatically generated content which reflects the entire web-branch of pages that are accessible from the specific link. The system further enables zooming between one or more websites, or groups of web pages to access the embedded content.

### CROSS REFERENCES TO RELATED APPLICATIONS

This application claims priority from and is related to U.S. Provisional Patent Application Serial No. 60/745,751, entitled: ONLINE INTERNET NAVIGATION SYSTEM AND METHOD, filed on Apr. 26, 2006 is incorporated by reference herein.

### FIELD OF THE INVENTION

The present invention relates generally to online Internet navigation systems, and more particularly to a system enabling rendering site content reflecting the entire web-branch of pages that are accessible from the specific link for each visitor to a web page based on his/her past and current behavior on the site.

### BACKGROUND OF THE INVENTION

The Internet as an online platform provides online users with an enormous amount of information, thus introducing an intrinsic problem of finding the relevant information out of a large volume of irrelevant or less relevant information. So far, the most successful tool to help online visitors with this challenge has been the Search Engine. Whether used for cross-site search over the internet (google.com, etc.) or for in-site search (“Powered by . . . ”), this technology matches a set of relevant web pages or documents to a user query.

It should be noted that the lack of effective and efficient navigation is a chief reason people are not ‘successful’ in their online experience, that is, they are not able to complete the task for which they initiated the online session. This has immediate implications for online conversion rates, the portion of online visitors that actually transact online, or more explicitly the ratio of ‘online transactions’ to ‘online sessions’, where a transaction can be placing an order or simply signing up to get promotions through email.

An obvious limitation of a web page is the amount of information one can present effectively on a page. Therefore visitors go through sequential browsing, where they identify a link on the current page that seems to be related to what they are looking for, they click through the link and that takes them to a new page. The new page hopefully contains more relevant information for their purpose. If not, they have to backtrack to the previous page and try another link.

Several websites, such as Netflix and SeamlessWeb, have utilized the “mouse-over” (cursor-over) capability to show a visitor specific content from the linked page when the cursor, controlled by the mouse, hovers over the link.

The underlying techniques for these two examples are different, but the common aspects are:
Using the mouse-over to show a ‘peek’ into the next page,
The actual content presented upon mouse-over is static to the link, often retrieved from a database, and does not vary from one visitor to the next, and
The content matches the referred page only and not possible links from that page.

There are several prior art inventions which relate to the subject of the present invention, but which have significant differences and drawbacks. For example:

U.S. Pat. No. 6,924,828 and U.S. Pat. No. 6,836,768 to Hirsch—both provide an information search and navigation system, indexes, and categorizes and condenses data from text or other documents. In various embodiments, this invention further utilizes user information goals, document or website types and multi-page link path options that together provide a fast, multi-page Web navigation system. The disadvantage of this invention is that it treats the content as static and does not assign the most appropriate content to each visitor. Content is parsed and analyzed without the information of how and when users access the content.

U.S. Pat. No. 6,928,474 to Venkatesan provides a web based technique for predicting future web navigation sequences of users visiting a web site includes, in one example embodiment, a web server having browsable web pages including products and services offered by a business. A web-monitoring tool monitors web navigation sequences performed by each user while browsing the web pages of the web site. A probability associative matrix (PAM) analyzer analyzes each of the monitored web navigation sequences to predict the web navigation sequences of future users visiting the web site. A web site administrator manually implements changes to the web site based on the analysis of the monitored web navigation sequences by the PAM analyzer to enhance the effectiveness of the web site in promoting businesses providing goods and services and make the system user friendly. This invention uses a different business application and lacks an online engine. The enhancement of the site is done manually, rather than through content templates and an assignment manager as in the present invention.

Therefore, it would be desirable to provide an Internet navigation system which will overcome the drawbacks of the prior art and more efficiently and effectively meet the needs, in real-time, of users visiting web pages/sites of their choosing.

### SUMMARY OF THE INVENTION

The present invention introduces a new technology that helps online visitors navigate more successfully, effectively and efficiently. Different visitors find different sections of the visited web page to be relevant for their current session. In fact the same visitor may find different things relevant on different sessions. The present invention renders specific content for each visitor based on the visitor's past and current behavior on the site (or possible cross-sites). A marketer can configure the content using this system and is also given the ability to embed automatically generated content. This embedded content is generated to reflect the entire web-branch of pages that are accessible from the specific link. That is, some information will be selected from the immediate page, but additional information will be selected from secondary pages that are linked from the immediate page and accessed using web-page tags. In a preferred embodiment of the invention, the system enables zooming between one or more websites, or groups of web pages to access embedded content and is hereinafter referred to as a “Page-zoom” system and method.

Accordingly, it is a principal object of the present invention to overcome the disadvantages and drawbacks of the prior art and to provide a method for enabling website navigation comprising:

a) providing web-page tags with capabilities for rendering specific content for each visitor to a web page/site based on the past and current behavior of said visitor on said web page/site;

b) providing configurable content templates and editable content embedded in said web page/site;

c) generating content specific to said visitor reflecting the entire web-branch of pages that are accessible from at least one designated link to said web page/site;

d) providing a real-time delivery means for the real-time delivery of said specific content to a web page/site each and every time said visitor on said web page/site places the cursor over said at least one designated link; and

e) providing a configuration means for configuring said specific content.

There is further provided a system for enabling website navigation comprising:

a) web-page tags with capabilities for rendering specific content for each visitor to a web page/site based on the past and current behavior of said visitor on said web page/site;

b) configurable content templates and editable content embedded in said web page/site;

c) content specific to said visitor reflecting the entire web-branch of pages that are accessible from at least one designated link to said web page/site;

d) a real-time delivery means for the real-time delivery of said specific content to a web page/site each and every time said visitor on said web page/site places the cursor over said at least one designated link; and

e) a configuration means for configuring said specific content.

Examples of embedded content provided by the inventive Page-zoom system to visitors to a website include:

the paragraph that best matches the search engine query that brought the visitor to the site;

the paragraph that best matches the last three pages viewed by the user;

the titles of the most visited pages linked (directly and indirectly) from the immediate page; and

the titles of those pages that are linked from the immediate page only by similar visitors (visitors of the same segment).

Web-page tags are embedded on website pages to enable them with Page-zoom capabilities in accordance with the principles of the present invention. The system uses JavaScript tags comprising an initiating tag and a link tag to be embedded by the user (typically the webmaster of the site).

In another embodiment of the present invention, a segmentation sub-system is provided that assigns visitors to segments. When the website is not providing a segment name for some visitors, the Page-zoom system can select the best-fit segment using the segmentation sub-system, or alternatively request a segment name from an external segmentation system.

Other features and advantages of the invention will become apparent from the following drawings and descriptions.

### BRIEF DESCRIPTION OF THE DRAWINGS

For a better understanding of the invention in regard to the embodiments thereof, reference is made to the following drawings, not shown to scale, in which like numerals and letters designate corresponding sections or objects throughout, and in which:

FIG. 1 is a flow diagram of a real-time delivery means for the real-time delivery of Page-zoom content in accordance with a preferred embodiment of the present invention;

FIG. 2 is a block diagram of the structure of a Page-zoom link request;

FIG. 3 is a block diagram of the structure of a Page-zoom system request;

FIG. 4 is a flow diagram of a configuration means for configuring the Page-zoom content by a marketer in accordance with a preferred embodiment of the present invention; and

FIG. 5 is a flow diagram of a Segmentation Sub-system in accordance with a preferred embodiment of the present invention.

### DETAILED DESCRIPTION OF PREFERRED EMBODIMENTS

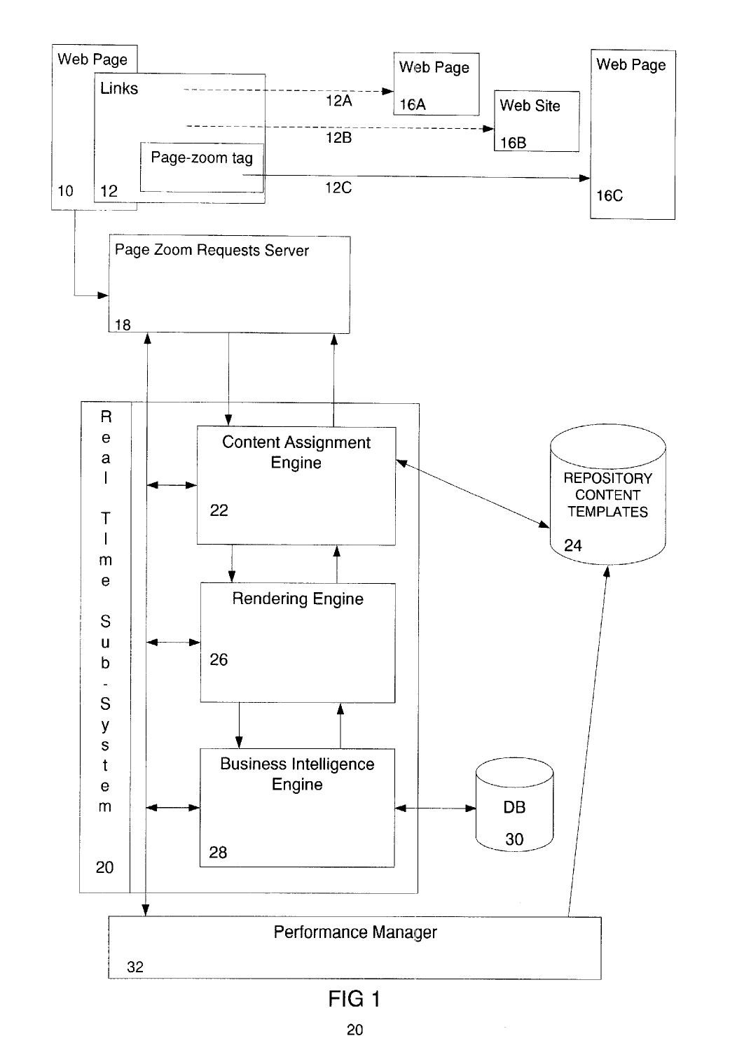

FIG. 1 is a flow diagram of a real-time delivery means for the real-time delivery of Page-zoom content in accordance with a preferred embodiment of the present invention. A site visitor, or customer from a marketing segment A₇ is visiting on web page 10. Web page 10 has several links 12A/B/C to other pages or sites 16A/B/C, as well as a web-page tag, such as Page-zoom (PZ) tag 14 embedded in Link 12C. Link 12C points to another web page 16C as indicated by the solid arrow. The visitor has placed the mouse over Link 12C activating PZ tag 14, which contains instructions to retrieve content for Link 12C. Tag 14 may request the content assigned to the target Web Page 16C, and may additionally specify the segment, such as A, where the request parameters can specify that the content should be selected to match that segment A. This is accomplished when PZ tag 14 sends a request to a Page-zoom Requests Server 18, in communication with one of the modules of a real-time delivery means such as Real-time Sub-system 20.

Real-time Sub-system 20 comprises the following modules: Content Assignment Engine 22, Rendering Engine 26, Business Intelligence Engine 28, and Performance Manager 32.

The Content-Assignment Engine 22 (real time) is responsible for selecting the Page-zoom Content Template for each designated link in real-time. It can select the Content Template according to the visitor segment and/or the target link.

The Rendering Engine 26 is responsible for real-time rendering of content templates into finalized content to be displayed. Finalized content can be of any type that is supported on internet browsers including, but not limited to: .gif, .jpg, .html, and the like. Rendering Engine 26 also provides for real-time embedding of variables and Custom Objects in templates.

A Business Intelligence (BI) Engine 28 is responsible for managing the site navigation information that is required for rendering the Custom Objects, including hash maps DB 30 for providing visitor information.

A Performance Manager 32 is responsible for caching and pre-fetching content templates and rendered templates for enhanced performance. It calculates the templates and system objects required for likely links on the page in advance while visitor is loading the page. In one embodiment, the pre-fetching and pre-calculation will be performed for the page(s) next likely to be viewed by the visitor.

The real-time delivery means of FIG. 1 is thus implemented, by way of example, by providing a Real-Time Sub-system 20. Page-zoom Requests Server 18 sends the request to the Content-assignment Engine 22 which retrieves the appropriate content template from the Content Templates Repository 24. After retrieving the content template, it sends it to a Rendering Engine 26 for real-time rendering. Rendering Engine 26 checks whether the template requires real-time rendering for Custom Objects and/or Variables. If required, it requests the corresponding content parameters from a Business Intelligence (BI) Engine 28 and renders the template to generate the final content in the specified format (html, dhtml, gif jpg, and the like). BI Engine 28 maintains navigation intelligence information using internal hash-maps that it also stores and retrieves through DB 30. It utilizes these hash maps to respond to requests for information. The content is sent back to the Content Assignment Engine 22, which sends it back to the Requests Server 18 which sends it to web page 10.

The Performance Manager 32 monitors the entire activity of requests coming into PZ Requests Server 18 and the templates retrieved by Content Assignment Engine 22; it determines which templates should be cached in memory for faster access, and which templates need to be pre-fetched in anticipation of future requests.

A Content Template is an object that contains:
a. baseline content (code—html, dhtml, and the like) or image (gif, jpg, and the like);
b. names for variables that will be resolved in real time; and
c. pointers to Custom Objects that will be rendered in real time. The custom objects contain dynamically generated content that is managed by the BI engine.

BI Engine 28 keeps track of the navigation sequences on the site so it can respond to requests to provide the list of all/most popular links on each page with a distribution of clicks-through each link by each segment. It also provides the list of all/most popular links in the K-level navigation tree through the target. Frequency counts will be managed by segment and a text. summary of each web page. The summary may be different for each segment. BI Engine 28 also maintains hash maps utilizing DB 30 when needed, including the following;

a) a hash map associating a Page Key with the set of pages linked from that page and also storing the frequency counts for visitors clicking through to the set of pages;

b) a hash map associating a Page Key with the set of all pages that link to that page also storing the frequency counts for visitors clicking through to the set of pages;

c) a hash map associating a Page Key with the set of the top N pages within K-click-distance from the page;

d) the hash maps in a), b), and c) where the key also contains a Segment Name component and also is provided with multiple values for each key;

e) a hash map associating a Segment Name with the frequent search terms for visitors in the segment; and

f) a hash map associating a Segment Name with the titles of frequent pages visited by visitors in the segment.

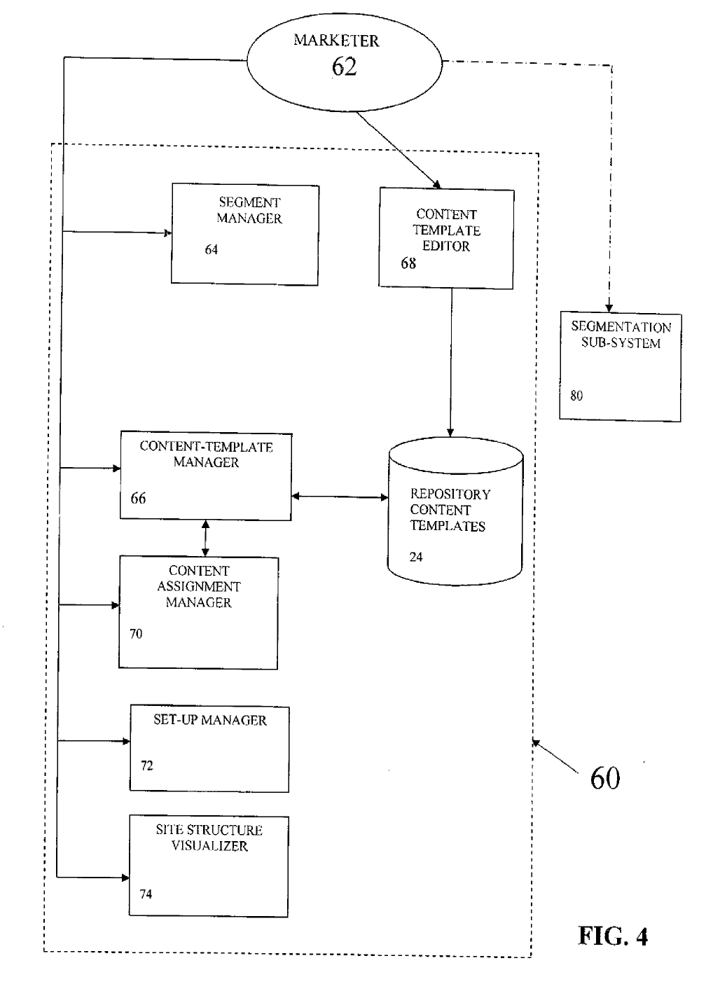

It should be noted that the values for N and K in c) are defined when a configuration means, such as Configuration Sub-system 60 (see FIG. 4) is activated.

The BI Engine 28 utilizes the above-mentioned hash maps to respond to requests for information, as described hereinbefore. In order to provide response for a text summary of each web page, the BI Engine 28 stores keywords or sentences of the target page that are related to text viewed by the visitor in previous pages. This is done by matching the search-engine query with the content of the linked page and extracting the information with the highest matching score. Alternatively, summaries are generated by matching keywords/phrases that are associated with the segment.

In another embodiment of the present invention, Business Intelligence Engine 28 also uses criteria in addition to click-through frequencies when ranking candidates for a list of all/most popular links on each page and for a list of all/most popular links in the K-level navigation tree through the target. The criteria comprise links not yet visited by the current visitor as well as links which were visited by other visitors closely in time to the visit by the current visitor.

Content rendered by the BI Engine 28 includes:
a list of all links in the target (optionally with click-through rates or frequency counts);
a list of most popular N₁ links (i.e., links most frequently clicked-through) in the target (optionally with click-through rates or frequency counts);
a list of most popular N₂ links (i.e., links most frequently clicked-through) in the K-level navigation tree through the target; and
a text summary for the target which is configurable by a marketer and can be the same for all visitors or broken down by segment.

It should be noted that an automatic summary of the page is provided by the system and is generated over all visitors or by segment.

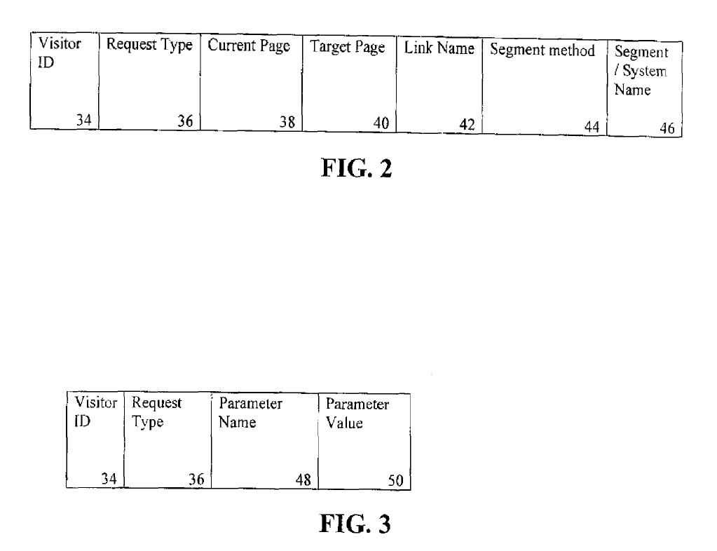

FIG. 2 is a block diagram of the structure of a Page-zoom link request in accordance with the principles of the present invention.

Page-zoom link requests are generated at the Page-zoom Tag 14 (see FIG. 1) and sent to the PZ Requests Server 18 (see FIG. 1). The request has the following components (some may be empty or null):
Visitor ID 34 provides a unique identifier of the current visitor;
Request Type 36, comprising, for example:
   retrieve content by target page,
   retrieve content by current page and segment name,
   retrieve content by link name, and
   retrieve content by link name and segment name;
Current Page 38 provides identifying information for the current page, such as the page url, the page title, or the page name;
Target Page 40 provides identifying information for the target page in this link such as the page url the page title, or the page name;
Link Name 42 provides an optional name for the link which can be used in the system's user interface to identify the link;
Segment Method 44 indicates how the segment is to be resolved for this request; and
Segment/System Name 46 provides the market segment of the visitor or the name of the segmentation system that will determine the market segment for the visitor.

Note that Visitor ID 34 may be null to indicate that information should be retrieved by the Page-zoom Requests Server 18 (see FIG. 1) through the visitor's cookie. It may be (−1) to indicate that the visitor does not accept cookies.

Examples of Segment Method 44 comprise;
Segment specified in the field Segment/System Name 46;
Segment to be evaluated. The segment can be evaluated within the Page-zoom system or through an external system. The name for the segmentation system is provided in field Segment/System Name 46; and
Segment to be carried over from last request for this visitor. When this is the first request, segment to be evaluated. The name for the segmentation system is provided in the field Segment/System Name 46.

FIG. 3 is a block diagram of the structure of a Page-zoom system request in accordance with a preferred embodiment of the present invention. Page-zoom system requests are generated at the Page-zoom Initiating Tag (see Web tags below) and sent to the PZ Requests Server 18 (see FIG. 1). The request comprises, by way of example, the following components, some of which may be empty or null:
Visitor ID 34 provides a unique identifier for the current visitor;
Request Type 36 which may, for example, set the visitor segment to the name in the field Segment Name 46 (see FIG. 2) or set certain cache/pre-fetch parameters for the Performance Manager 32 (see FIG. 1);
Parameter Name 48 provides the name of a parameter to be set (when applicable); and
Parameter Value 50 fixes the value of a parameter as given in Parameter Name 48.

Note that Visitor ID 34 may be null to indicate that information should be retrieved by the Page-zoom requests server through the visitor's cookie. It may be (−1) to indicate that the visitor does not accept cookies.

FIG. 4 is a flow diagram a configuration means for configuring the Page-zoom content by a marketer in accordance with a preferred embodiment of the present invention. FIG. 4 shows a general view of the configuration means, such as Configuration Sub-System 60 which comprises modular functioning units. Configuration Sub-system 60 allows a Marketer 62 to configure a real-time delivery means, such as Real-time Sub-system 20 (see FIG. 1).

Segment Manager 64 is a user interface which allows Marketer 62 to define the names for visitor segments. In real-time, it is assumed that requests coming to the system will include the segment of the current visitor, or alternatively that the segment is to be determined by either the Page-zoom system or by an external system.

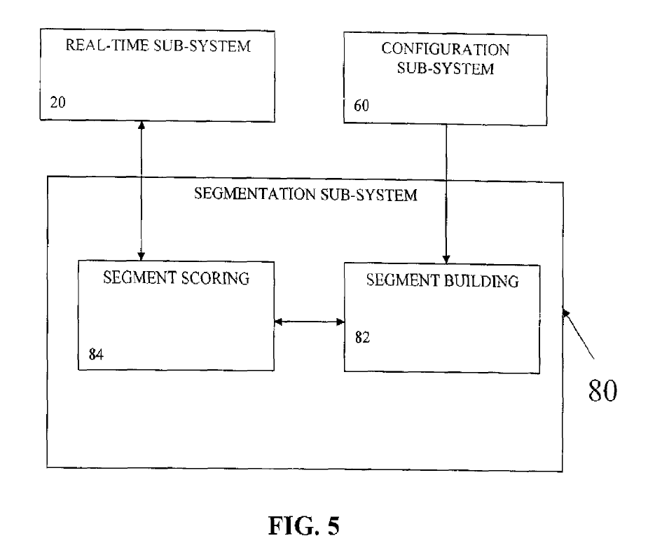

The user interface Segment Manager 64 allows Marketer 62 to configure a connection with a Segmentation System 80. The segmentation system may be the Segmentation Sub-system of the present invention (see FIG. 5) or an external segmentation system. Marketer 62 can also specify a set of keywords to be associated with each segment.

A Content Template Manager 66 is in communication with Content Template Repository 24 with predefined templates. Custom-built templates are added by Marketer 62 to Content Template Repository 24 utilizing Content Template Editor 68. Template Editor 68 enables:
inputting the baseline content (code or image);
inputting the names of variables to be associated with the template and the locations they are to be rendered into the template; and
embedding pointers to one or more Custom Objects and specifying their type.

A Content-Assignment Manager 70 provides Marketer 62 with the ability to configure the corresponding component of the Real-time Sub-system 20 (see FIG. 1), i.e., Content Assignment Engine 22 (see FIG. 1).

Content Assignment Engine 22 (see FIG. 1) provides the following functions:
creates names for links on the site that are to be managed by this system;
assigns a Page-zoom content template that will be displayed for visitors in that segment that mouse-over the link for each Named Link and Visitor Segment or a Target Page and Visitor Segment;
assigns a Page-zoom content template to a combination of a Link Set and a Segment Set; and
assigns a text summary with each Link Name or Target Name to be embedded as a Custom Object.

It is understood that, in accordance with the principles of the present invention, the content template will be rendered in real-time to create the final content.

A Link Set comprises at least one of the following: a single link, a pattern of link names, and a group of link patterns. A Segment Set comprises at least one of the following: a single segment name, a pattern of segment names, and a group of segment patterns. Similarly, the marketer can assign a content template to a combination of a Segment Set and a Target-Page Set. A Target-Page Set comprises at least one of the following: a single link, a pattern of link names, and a group of link patterns.

Setup Manager 72 provides for setting up global configuration parameters such as:
the tree-depth (K) for the business intelligence engine;
the number N₁ of most popular links to be tracked from each page; and
the number N₂ of most popular links to be tracked for the sub-tree below each page.

Site Structure Visualizer 74 comprises a tool to visualize the site structure through graphical representation of the links between pages.

FIG. 5 is a general view of a Segmentation Sub-system 80 in a preferred embodiment of the present invention. Alternatively, segmentation services can be provided through an external segmentation system. Segmentation Sub-system 80 is comprised of two modules: a Segment-building module 82 and a Segment-scoring module 84.

Segment-building module 82 uses clustering algorithms to cluster together visitors with similar navigation and conversion patterns and to match the keywords sets, Marketer 62, through Segment Manager 64 (see FIG. 4), can associate a list of keywords with the segment, in the sense that visitors to that segment are expected to come to the site using these keywords for search, and are further expected to browse pages with them. In other words, the keywords list describes the domain of interest of the segment defined by Marketer 62 as described heretofore in relation to Segment Manager 64. Segment-scoring Module 84 scores visitors in real-time against the clusters built by Segment-building module 82. Segment-building Module 82 adjusts the segments periodically (the frequency is configurable) based on new data collected by the system.

Web-Page Tags

An initiating tag defines the Page-zoom layer (through a DIV tag, an IFRAME tag or a similar html/dhtml object tag) on the current document object and sets the layer to be invisible (hidden), It sets the environment for communication with the Page-zoom server and establishes contact with the Page-zoom Requests Server 18 (see FIG. 1). This tag may optionally send a request to set the visitor segment. Moreover, it sends requests to communicate visitors activity on the site to Business Intelligence (BI) Engine 28 (see FIG. 1) for managing Custom Objects. It may optionally send parameters for Performance Manager 32 (see FIG. 1) with settings for caching and pre-fetching.

Link tags provide Page-zoom content for designated links on each page. These tags specify the “MouseOver” (cursor over the link) and “MouseOut” (cursor moved off the link) attributes of the href tag that is used for the link. It may also modify the “OnClick” (clicking on the mouse) action. The MouseOver action is set to display a layer over the current link. The layer is pre-established by the initiating tag. The layer is positioned according to the location of the link and the cursor. It is set to be visible and its content is assigned to an http/https request to the Page-zoom server. The MouseOut action is set to hide the Page-zoom layer. The OnClick action may be modified to hide the Page-zoom layer in addition to its normal behavior.

Having described the invention with regard to certain specific embodiments, it is to be understood that the description is not meant as a limitation, since further modifications may now suggest themselves to those skilled in the art, and it is intended to cover such modifications as fall within the scope of the described invention and related drawings and claims.

I claim:

1. A method for enabling website navigation, said method comprising the steps of;
a) providing web-page tags with capabilities for rendering specific content for each visitor to a web page/site based on the past and current behavior of said visitor on said web page/site;
b) providing configurable content templates and editable content embedded in said web page/site;
c) generating content specific to said visitor reflecting the entire web-branch of pages that are accessible from at least one designated link to said web page/site;
d) providing a real-time delivery means for the real-time delivery of said specific content to a web page/site each and every time said visitor on said web page/site places the cursor over said at least one designated link; and
e) providing a configuration means for configuring said specific content.

2. The method of claim 1 wherein said real-time delivery means comprises a Real-time Sub-system comprising:
a Content-Assignment Engine for selecting said content template for each said at least one designated link in real time;
a Rendering Engine for real-time rendering into finalized content to be displayed of content templates, embedded variables and custom objects;
a Business Intelligence Engine for managing the site navigation information that is required for rendering said embedded variables and custom objects; and
a Performance Manager for caching and pre-fetching said content templates.

3. The method of claim 1 wherein said configuration means comprises a Configuration Sub-system comprising:
a) a Segment Manager for defining and configuring customer segmentation for providing a user interface;
b) a Content-Template Manager, including a Repository for storing said configurable content templates and editable content;
c) a Content-Assignment Manager for:
creating link names for links on the site that are to be managed by said configuration sub-system;
assigning said Page-zoom content templates that will be displayed for visitors that mouse-over said links; and
assigning a text summary with each of said link names to be embedded as said variables and custom objects;
d) a Setup Manager for setting up global configuration parameters; and
e) a Site Structure Visualizer for providing a graphical representation of the links between pages.

4. The method as in claim A where said specific content is assigned uniformly for all visitors.

5. The method as in claim 1 where said specific content is assigned per customer segment.

6. The method as in claim 1 where said specific content is defined through a content template.

7. The method as in claim 6 wherein said content template comprises at least one of:
a baseline content code;
an image file;
names for variables that will be resolved in real time; and
pointers to Custom Objects.

8. The method as in claim 7 wherein said Custom Objects include at least one of the following parameters selected from the group:
list of all links to the target;
list of most frequently clicked-through N₁ links in the target;
list of most frequently clicked-through N₂ links in the K-level navigation tree through the target;
text summary configurable for said target; and
automatically generated summary of a page.

9. The method as in claim 8 wherein said links to the target page are fArther provided with optional ranking through features of at least one of: click-through rates and frecqucncy counts.

10. A system for enabling website navigation, said system comprising:
a) web-page tags with capabilities for rendering specific content for each visitor to a web page/site based on the past and current behavior of said visitor on said web page/site;
b) configurable content templates and editable content embedded in said web page/site;
c) content specific to said visitor reflecting the entire web-branch of pages that are accessible from at least one designated link to said web page/site;
d) a real-time delivery means for the real-time delivery of said specific content to a web page/site each and every time said visitor on said web page/site places the cursor over said at least one designated link; and
e) a configuration means for configuring said specific content.

11. The system as in claim 10 wherein said real-time delivery means comprises a Real-time Sub-system comprising:
a Content-Assignment Engine for selecting said content template for each said at least one designated link in real time;
a Rendering Engine for real-time rendering into finalized content to be displayed of content templates, embedded variables and custom objects;
a Business Intelligence Engine for managing the site navigation information that is required for rendering said embedded variables and custom objects; and
a Performance Manager for caching and pre-fetching said content templates.

12. The system as in claim 10 wherein said configuration means comprises a Configuration Sub-system comprising:
a) a Segment Manager for defining and configuring customer segmentation for providing a user interface;
b) a Content-Template Manager, including a Repository for storing said configurable content templates and editable content;
c) a Content-Assignment Manager for:
creating link names for links on the site that are to be managed by said configuration sub-system;
assigning said Page-zoom content templates that will be displayed for visitors that mouse-over said links; and
assigning a text summary with each of said link names to be embedded as said variables and custom objects;
d) a Setup Manager for setting up global configuration parameters; and
e) a Site Structure Visualizer for providing a graphical representation of the links between pages.

13. The system as in claim 10 where said specific content is assigned uniformly for all visitors.

14. The system as in claim 10 where said specific content is assigned per customer segment.

15. The system as in claim 10 where said specific content is defined through a content template.

16. The system as in claim 15 wherein said content template comprises at least one of the parameters selected from the group comprising:
baseline content-baseline code;
an image;
image code;
names for variables that will be resolved in real-time; and
pointers to Custom Objects.

17. The system as in claim 16 wherein said Custom Objects include at least one of the following selected from the group:
list of all links to the target;
list of most frequently clicked-through Ni links in the target; list of most frequently clicked-through N₂ links in the K-level navigation treethrough the target;
text summary configurable for the target; and
automatic summary of a page provided by said system.

18. The system as in claim 17 wherein said links to the target are further provided with optional ranking through at least one of: click-through rates and frequency counts.
